(19) United States
(12) Patent Application Publication
(10) Pub. No.: US 2005/0145081 A1
(43) Pub. Date: Jul. 7, 2005

(54) Device for sectioning samples

(75) Inventors: Rainer Wogritsch, Vienna (AT); Anton Lang, Vienna (AT)

Correspondence Address: S. Peter Konzel, Esq.;Simpson & Simpson, PLLC, 5555 Main Street, Williamsville, NY, 14221, US

(73) Assignee: Leica Mikrosysteme GmbH, Vienna (AT)

(21) Appl. No.: 11/021,371

(22) Filed: Dec. 23, 2004

(30) Foreign Application Priority Data
Jan. 7, 2004 (DE) 102004001281.4-82

(51) Int. Cl. B26D 7/10; F25C 5/02; F25D 3/08

(52) U.S. Cl. 83/170; 83/915.5; 62/320

(57) ABSTRACT

A device for sectioning samples, which encompasses a sectioning apparatus for generating thin sample pieces and a table for placement of the sectioning apparatus thereon. Displaceable arm supports, which are adjustable to a user's ergonomics and to a configuration of the device, are provided on the table opposite the knife holder and sample holder of the sectioning apparatus.

### CROSS REFERENCE TO RELATED APPLICATIONS

This application claims priority of the German patent application 10 2004 001 281.4 which is incorporated by reference herein.

### FIELD OF THE INVENTION

The invention concerns a device for sectioning samples.

### BACKGROUND OF THE INVENTION

Microtomes and ultramicrotomes are, as a rule, equipped with at least one knife that serves to produce thin sections of the sample. Microtomes and/or ultramicrotomes can be as well surrounded by a cooling chamber.

The Leica EM FCS cooling chamber (“Low-Temperature Sectioning System” brochure) possesses a hand support on the right side (for right-handers only). No hand supports are offered for use of the sectioning apparatus at room temperature. A user's elbow or elbows must float over the table surface. Since the cooling chamber is separated from the unit by rubber insulation, disturbances due to hand movement are not transferred to the unit. This hand support on the cooling chamber can also be used during the sectioning operation.

An ultramicrotome from the RMC company (see “RMC Ultramicrotomes” catalog) that has supports for the balls of the user's hands mounted on the housing is known. These hand supports are usable only for the room-temperature version. Installation of the hand supports on the unit itself has the great disadvantage that all movements of the hand are transferred to the unit as a disturbance. This hand support is therefore not intended to be used during the cutting operation. When the cryobox is set in place, the hand supports are removed. It is precisely for this application, however, that manipulation of the sections is most difficult.

Devices of the existing art have the critical disadvantage that no supports are provided for the user's elbows. Users work in some cases with their elbows lifted, which results in fatigue. In another position they rest the tips of their elbows on the table surface, which is ergonomically very unfavorable.

### SUMMARY OF THE INVENTION

It is therefore the object of the present invention to create a device with which an ergonomic working position can be achieved for each different user. A further intention is that it also be possible to work with the device for long periods without fatigue.

According to the present invention, this object is achieved by way of a device for sectioning samples, which comprises:

a sectioning apparatus for generating thin sample pieces,

a table for placement of the sectioning apparatus thereon, wherein the sectioning apparatus possesses a knife holder and a sample holder,

a cooling chamber surrounds the knife holder and the sample holder,

a horizontal rail is mounted to the table, opposite to the knife holder and the sample holder, and

displaceable arm supports are provided in the rail, and supports for user's hands are provided on the cooling chamber, wherein the arm supports are adjustable to a user's ergonomics and to a configuration of the device, so that the user, while using the sectioning device together with the cooling chamber has his elbows supported by arm supports and the hands are resting on the supports for user's hands.

For use at low temperatures, the microtome or ultramicrotome can be provided with a cooling chamber.

Furthermore, the device also advantageously encompasses, on the table, a control unit for controlling and regulating the sectioning apparatus and/or the cooling chamber. The control unit comprises a display and an input unit. The display can also be embodied as a touchscreen so that some functions of the sectioning device and the cooling chamber can be controlled therewith.

It is advantageous in terms of fatigue-free operation if the cooling chamber also comprises supports for a user's hands. When using a microtome or ultramicrotome together with a cooling chamber, a user will support his or her elbows on the arm supports of the table, and rest his or her hands on the two supports on the cooling chamber.

Further advantages and advantageous embodiments of the invention may be inferred from the dependent claims, and are the subject matter of the Figures below as well as the descriptions thereof.

### BRIEF DESCRIPTION OF THE DRAWINGS

In the individual Figures:

FIG. 1 is a perspective view of a device for sectioning samples;

FIG. 2 is a perspective view of a further embodiment of the device for sectioning samples;

FIG. 3a is a side view of the arm supports, depicting the various possibilities for adjusting the arm supports in the vertical direction; and

FIG. 3b is a plan view of the arm supports, showing the various possibilities for adjusting the arm supports in the horizontal direction.

### DETAILED DESCRIPTION OF THE INVENTION

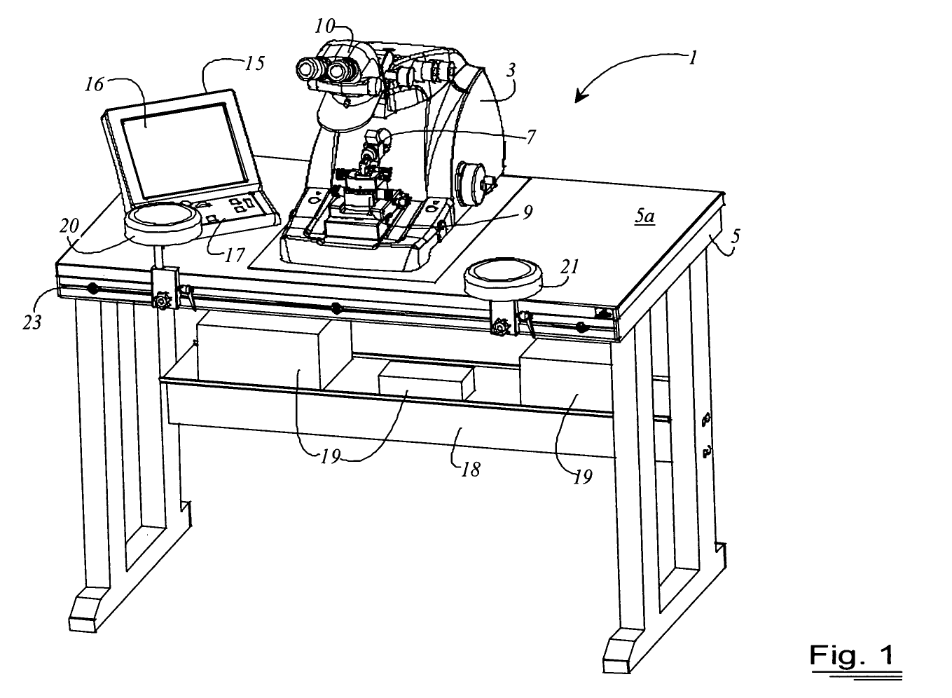

FIG. 1 is a perspective view of a device 1 for sectioning samples. Device 1 encompasses a sectioning apparatus 3 for generating thin sample pieces. Sectioning apparatus 3 is placed on a table 5 that defines a table surface 5a. Sectioning apparatus 3 possesses at least one knife holder 9 and one sample holder 7. Displaceable arm supports 20 and 21 are provided on table 5 opposite knife holder 9 and sample holder 7 of sectioning apparatus 3. Arm supports 20 and 21 are adjustable to the ergonomics of a user and to a configuration of the device. Table 5 is provided with a vibration-damped insert 40 on which sectioning apparatus 3 stands. Additionally provided on table 5 is a control unit 15 for controlling and regulating sectioning apparatus 3. Control unit 15 encompasses a display 16 and an input unit 17. Provided beneath table surface 5a of table 5 is a platform 18 on which electronics and power-supply modules 19 are placed.

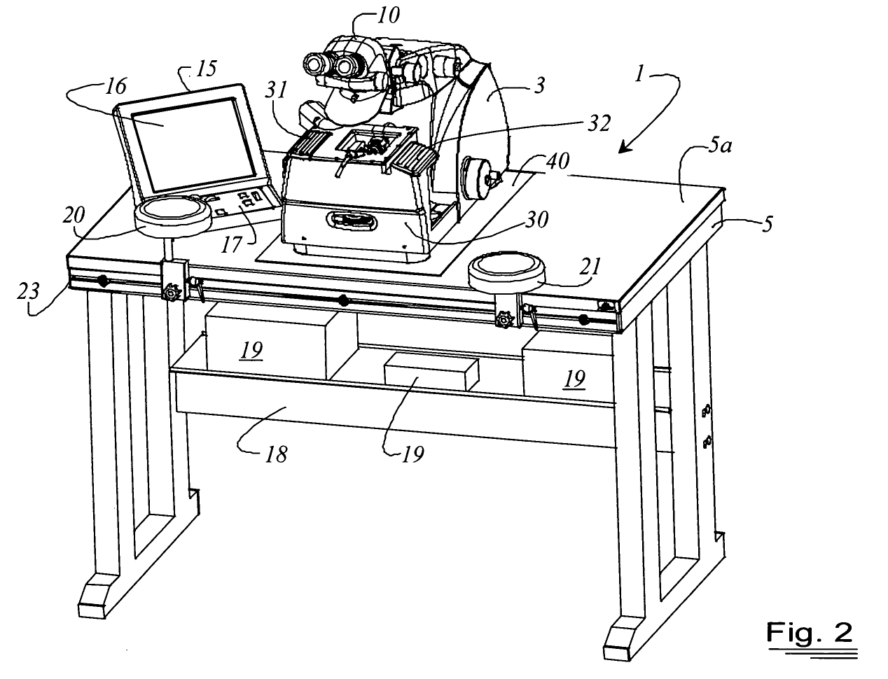

The configuration of device 1 comprises a microtome. In another configuration, device 1 comprises an ultramicrotome. In a further configuration, device comprises a cooling chamber 30 (see FIG. 2) that encloses knife holder 9 and sample holder 7 of cutting apparatus 3.

As is evident from FIGS. 1 and 2, a rail 23 is mounted on table 5 opposite knife holder 9 and sample holder 7. Arm supports 20 and 21 are mounted in horizontally displaceable fashion in rail 23. A stereomicroscope 10 is provided with the sectioning apparatus 3 for observation of the sectioning operation by the user. Cooling chamber 30 (see FIG. 2) likewise comprises supports 31 and 32 for a user's hands. When a microtome or ultramicrotome is used as sectioning apparatus 3 together with a cooling chamber 30, the user rests his or her hands on supports 31 and 32 on cooling chamber 30, and supports his or her elbows on arm supports 20 and 21 of table 5.

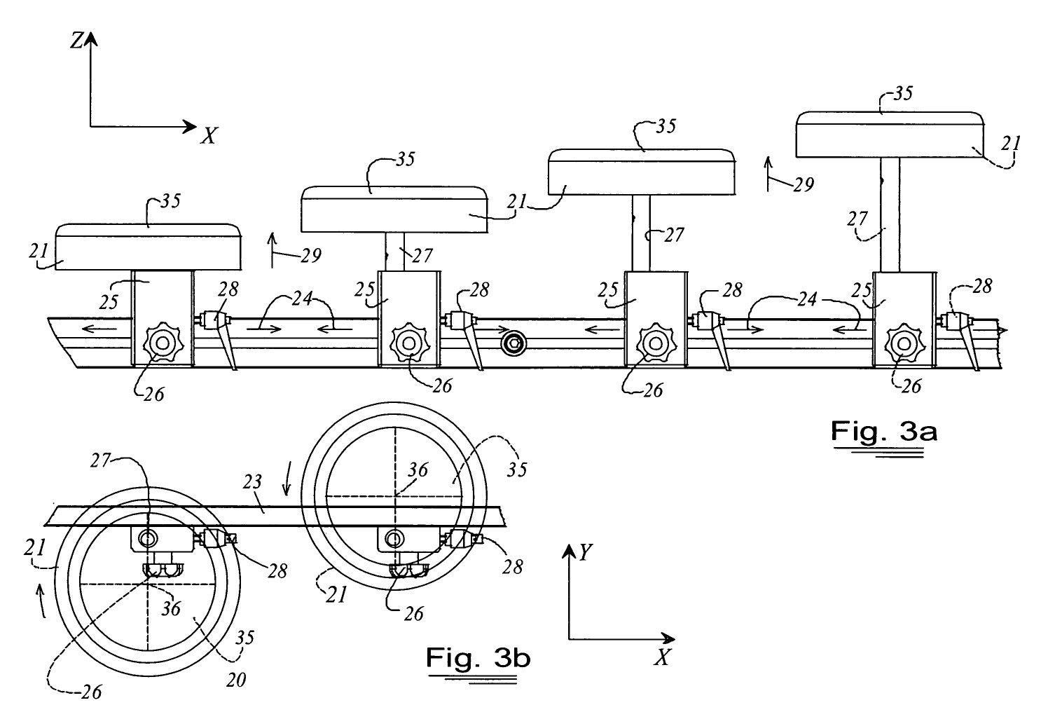

FIG. 3a is a side view of one of arm supports 20, 21, showing a variety of possible adjustments. The displacement capability of the arm supports in the vertical direction is shown in FIG. 3a. As already mentioned in the description of FIG. 1 and FIG. 2, a rail 23 is mounted on table 5 opposite knife holder 9 and sample holder 7. Arm supports 20 and 21 are mounted in horizontally displaceable fashion in rail 23. The horizontal implacability is indicated by arrows 24, likewise oriented horizontally. Arrows 24 mark the X direction. A slide block 25, which is arranged shift ably in the X direction in rail 23, serves to clamp arm supports 20, 21. By way of a wheel 26 provided on slide block 25, the latter can be clamped on rail 23 at a position set by the user. Each of arm supports 20, 21 is installed on a shaft 27. Arm supports 20, 21 are embodied displacably in terms of height (Z direction) along shaft 27. The height desired by the user is set by clamping using a lever 28. The displacement of arm supports 20, 21 in the Z direction is labeled in FIG. 3a with arrows 29. The displacement range of arm supports 20, 21 can be extended if correspondingly long shafts 27 are connected to the arm supports. Adapter pieces can likewise be attached to shaft 27 (this is not evident in detail from FIG. 3a). Each support surface 35 of arm support 20, 21 is provided with an elastic and ergonomically shaped material.

FIG. 3b is a plan view of arm supports 20, 21 that disclose the various possibilities for adjusting arm supports 20, 21 in the horizontal direction (Y direction). Since shaft 27 is not located at a center of symmetry 36 of arm supports 20, 21, a rotation of arm supports 20, 21 about shaft 27 also results in a horizontal shift (Y-direction shift). As already mentioned above, clamping is once again accomplished via levers 28.

1. A device for sectioning samples comprising:
a sectioning apparatus for generating thin sample pieces,
a table for placement of the sectioning apparatus thereon, wherein the sectioning apparatus possesses a knife holder and a sample holder,
a cooling chamber surrounds the knife holder and the sample holder,
a horizontal rail is mounted to the table, opposite to the knife holder and the sample holder, and
displaceable arm supports are provided in the rail, and supports for user's hands are provided on the cooling chamber, wherein the arm supports are adjustable to a user's ergonomics and to a configuration of the device, so that the user, while using the sectioning device together with the cooling chamber has his elbows supported by arm supports and the hands are resting on the supports for user's hands.

2. The device according to claim 1, wherein the configuration of the sectioning apparatus is a microtome.

3. The device according to claim 1, wherein the configuration of the sectioning apparatus is an ultramicrotome.

4. The device according to claim 1, wherein a control unit for controlling and regulating the sectioning apparatus and the cooling chamber is additionally provided on the table; and the control unit comprises a display and an input unit.

5. The device according to claim 1, wherein the arm supports are also vertically displaceable.

6. The device according to claim 1, wherein each of the arm supports is retained in a slide block that runs horizontally in the rail and is lockable by way of a wheel at a position in the rail selected by the user.

7. The device according to claim 6, wherein a shaft that is embodied displacably in the vertical direction in the slide block, and is clampable by way of a lever, is mounted on each arm support.

8. The device according to claim 7, wherein the shaft is arranged outside a center of symmetry of the arm support, so that a horizontal shift is additionally attainable by way of the rotation of the arm support about the shaft.

9. The device according to claim 1, wherein each arm support defines a support surface that is provided with an elastic material.

10. The device according to claim 1, wherein the table is a vibration-damped table.

11. The device according to claim 10, wherein the table is provided with a vibration-damped insert on which the sectioning apparatus stands.
